(19) United States
(12) Patent Application Publication
(10) Pub. No.: US 2003/0033237 A1
(43) Pub. Date: Feb. 13, 2003

(54) Method of valuating and trading customer information

(76) Inventor: Ritesh Bawri, Ann Arbor, MI (US)

Correspondence Address: John G. Posa, Gifford, Krass, Groh et al, 280 N. Old Woodward Ave., Suite 400, Birmingham, MI, 48009, US

(21) Appl. No.: 09/922,762

(22) Filed: Aug. 6, 2001

(51) Int. Cl. G06F 17/60

(52) U.S. Cl. 705/37

(57) ABSTRACT

A method of evaluating buyer information for sale to potential manufacturers, merchants, sellers, and the like reduces marketing costs through higher customer conversion rates and improved customer satisfaction. The customer information is priced using an inventive pricing algorithm. An information exchange is established to facilitate clients bidding on the information in the form of packets that contain a rich profile of the customer. Purchase of the information by the client (i.e., buyer) affords access to a circle of influence. Access to the information and the circle of influence allows the clients to own, know, and influence the customer at a critical time in the purchasing cycle, thereby creating a paradigm shift in managing customer demand and influencing customer decisions. In operation, the method reduces marketing costs through higher customer conversion rates and improved customer satisfaction. The model measures the value of information being made available to a vendor prior to purchase along with preferences, reflecting the usefulness of the information.

### FIELD OF THE INVENTION

This invention relates generally to the economic evaluation of information and, in particular, to methods of compiling, pricing, selling and using information from potential purchasers, particularly those interested in durable goods.

### BACKGROUND OF THE INVENTION

Economic transactions are driven by information. In the past, geography was a barrier to efficient information exchange. This was due to the inability to capture useful accurate information in real time. This resulted in inefficient markets and uninformed buyers and sellers. The impact of this is felt on lost opportunities both on the part of the buyer and the seller. More importantly this resulted in inefficient value chains with bloated inventory holding and frequent overstocking and/or stock outs. The process of eliminating geographic and market fragmentation as a barrier to commerce has been a key outcome of the Internet revolution. This has been an outcome of the unique ability of the Internet to ship information anywhere in the world within seconds, reducing information asymmetries.

In the last decade, millions of businesses have been collecting data about the purchasing habits of particular individuals, along with lifestyles, political preferences; shopping habits, credit history and payment habits. These companies have begun to realize the commercial value of information and have started to package and sell this data. This has lead to a rise in direct marketing, personal targeting and telemarketing using information collected from diverse sources. Companies have benefited from the availability of profiles of customers that grow richer over time.

There are two key trends with regard to customer information. First, companies are increasingly relying on the need to have accurate and timely information that can be acted on immediately. They are therefore using technology to dynamically capture and assimilate information about customers. Second, customers are realizing the value of their information and are becoming reluctant to give out information about themselves without adequate compensation. There is a need to balance these diverging trends and redistribute the value of customer information away from companies and toward customers.

Traditionally, customers have not had any control over either the sharing or use of their information. More importantly, they have not been adequately compensated for the value of their information. This has significantly heightened privacy concerns among customers. Privacy expert Alan Westin, who is a Professor at Columbia University, defined information privacy as the claim of individuals, groups or institutions to determine for themselves when, how, and to what extent information about themselves is communicated to others. (See Information policy committee of the National Information Infrastructure Task Force, Options for promoting privacy on the National Information Infrastructure available at www.nii.gov). Instead, customer data has been captured extraneously and used to market to them without their permission.

In the past two decades, driven by the increasing value of information, we have begun to view information as an asset itself, rather than just a tool to manage other assets. There is a growing need to recognize the fact that information is an asset and has value. Several leading authorities on information management have talked and written about the need to convert information into a “property right” that can be owned and controlled. Ownership of information would allow the customer to benefit from the information causing participation in the sharing of information. Participation would allow the capture and use of information in a dynamic manner by redistributing the value of the information in a more balanced manner.

In the last decade both legal and technological initiatives have gathered momentum to regulate the use of information. This has been in response to the growing backlash among customers about the abuse of their private and personal data. The typical response of both technological solutions like P3P, or legal solutions discussed by Congress, has been to regulate the use of information. While this is certainly better than having information captured by companies without consent, it still does not recognize the fact that information has value and customers should benefit from this value.

Gathering and selling of data, is legal in the United States. Companies retain the rights to use information captured extraneously without the permission of the customer. The legal regulation of information is driven by conflicting goals. While there is clearly a need to share information, in fact customers actually value appropriate information, there is a need to regulate the manner in which this information is captured and what is done with it. This has been the general thrust of legal bills that have sought to be introduced in the United States. The recently passed Gramm Leach and Bliley Financial Services Modernization Act which went into effect Jul. 1, 2001, seeks to restrict the sharing of non public private information with affiliates and non affiliates without informing the consumer as well as giving them the option of opting-out of sharing their information. The Direct Marketing Association has sought to prevent giving customers control over their own information. Instead they have intensely lobbied for companies to offer the customer an option to opt out of being on a mailing list. This has usually been buried in the privacy agreement usually not inducing the customer to opt out. Another interesting route taken by the Direct Marketing industry is to allow a customer to opt out altogether from all mailing lists or not opt out at all. Since customers obviously want to be sent some information it prevents them from opting out.

The privacy debate has led to several technological initiatives that seek to regulate the flow of information, with the goal being to restore some degree of control to the customer. AT&T, along with the Worldwide Web Consortium launched what they called the P3P solution to information sharing. P3P, a tool to regulate the type of information being shared by customers, would seamlessly integrate into a browser. Using this system, the customers can set their preferences about the type of information that they are willing to share. A significant shortcoming of P3P technology is that it only regulates the capture and use of information, instead of sharing the value of information. Moreover, P3P is currently facing several problems. For one, there is a patent pending that seeks to regulate the use of P3P, which has discouraged many large companies that were seeking to develop technology that leveraged P3P.

However, current solutions still seek to control the use of information, not reward customers for the value of their information. The result will be that while it may squeeze the flow of information, it still wont create information matching services in cases where information is required by the company, and the customer is willing to give it out in exchange for some value.

Information about customers purchase intent, demographics, likes, dislikes has a quantifiable benefit to companies, both before and during the purchase cycle, as depicted graphically in FIG. 1A. This information made available to companies while the customer is in the purchase cycle can be used to better target their customers, and therefore reduce the cost of customer acquisition. The value of information is driven by the quantity, the quality, and the timeliness in which it is made available. As shown in FIG. 1B, the value of information displays a unique characteristic of increasing in value as soon as the customer is in the purchase cycle.

Before the customer enters the purchase cycle such information has limited relevance. Also, as the customer closes in on the purchase decision, the value of the information drops, in close proportionality, to the time remaining to purchase the product due to the inability to act on this information. The time function is driven by the product and its own purchase cycle characteristics.

In the last decade, companies have begun to realize the value of detailed, accurate and timely customer information. More specifically, information about purchase intent, prior to purchase helps companies to identify potential customers and service their needs. However since most companies use data gathered without the consent of the customer, it affects the quality and timely availability of such information. Companies therefore usually enter the customers purchase cycle after the buying decision has been made, resulting in their inability to directly influence purchase.

### SUMMARY OF THE INVENTION

Broadly according to the method of this invention, buyers of services or goods such as durable goods willingly share information in the awareness, consideration, and preference stage about purchase intent. Access to this data allows companies to own, know, and influence the customer immediately prior to purchase. The customer information is priced using an inventive pricing algorithm. The model measures the value of information being made available to a vendor prior to purchase along with preferences, reflecting the usefulness of the information.

An information exchange is established to facilitate clients bidding on the information in the form of packets that contain a rich profile of the customer. Purchase of the information by the client (i.e., buyer) affords access to a circle of influence. Access to the information and the circle of influence allows the clients to own, know, and influence the customer at a critical time in the purchasing cycle, thereby creating a paradigm shift in managing customer demand and influencing customer decisions. In operation, the method reduces marketing costs through higher customer conversion rates and improved customer satisfaction.

### BRIEF DESCRIPTION OF THE DRAWINGS

FIGS. 1A and 1B are graphs which plot the value of customer information as a function of time;

FIG. 2 is a chart that illustrates the property value of information;

FIG. 3 is a chart that depicts the flow of information and value/marketing according to the invention;

FIG. 4 is a diagram that shows a bidding process according to the invention;

FIG. 5 is a web page that shows our clients using our information to market to customers on a personalized and individualized basis; and

FIG. 6 is a drawing used to illustrate an asymmetric security environment to regulate the flow of information between the customer and the client.

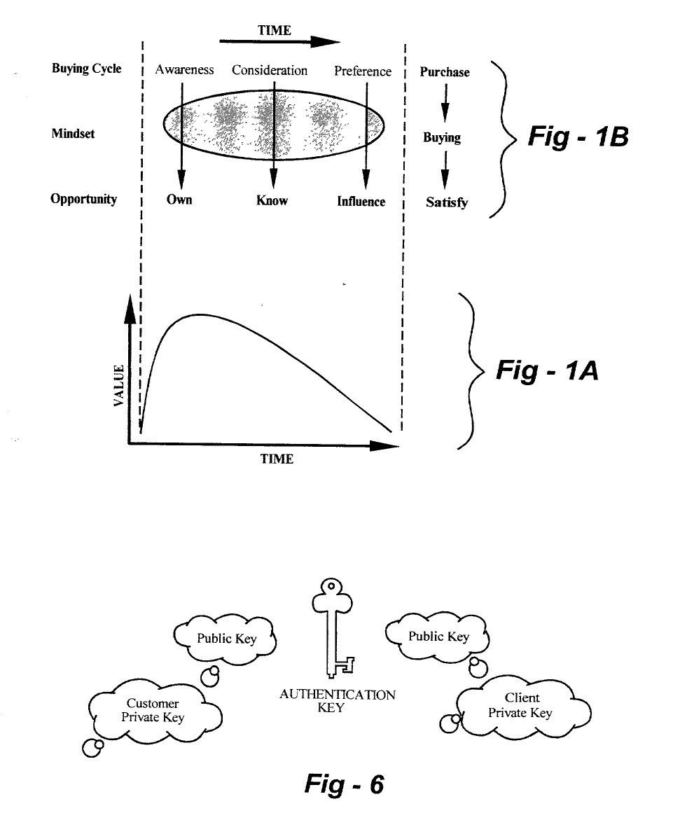

### DETAILED DESCRIPTION OF THE INVENTION

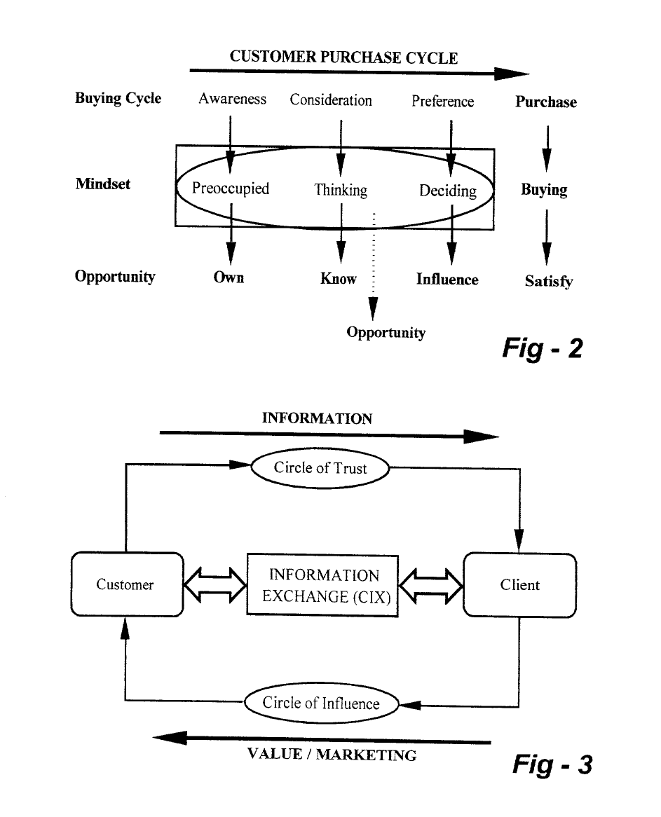

According to the invention, information is captured directly from customers while they are actively engaged in the purchase cycle (see FIG. 2). This information is then converted into an asset that can be owned by the customer. In the preferred embodiment, this information will be classified into multiple categories, the summation of which will create a rich profile of the customer. Such categories will preferably include, but are not limited to the following:

Demographic data, such as age, income, zip code;

Purchase Intent regarding the customer's desire to buy something;

Preferences about individual preferences as to product attributes;

Triggers about specific attributes that can sway purchase; and

Influencers regarding who or what influences the person

Merchants, vendors, and other clients will purchase these information packets and use it to better understand the customer. Most market research efforts simply cannot collect data about a customer from diverse sources sufficient to create such a rich profile of the customer. This information will allow vendors to target their potential customers in a very effective manner. Moreover, instead of waiting passively for the customer to enter their value chain, companies can now influence customers to convert.

The following table lists Functionalities of Information packet or assets provided through the invention:

| | Control | Facilitation |
|---|---|---|
| Capture | Customers can control | A link will be provided to customers |
| | both what information | whereby they can access the data that |
| | they share and when | they have shared and edit and change |
| | they share it | the data |
| Access | Customers can control | Customers will be continuously |
| | who gets access to their | informed about who has been given |
| | information by selecting | access to their information, how often |
| | clients | it has been looked at |
| Useage | Customers can control | Tools will be provided that allow |
| | what the information | customers to select clients based on |
| | is used for. They can | their preferences. This will give them |
| | regulate unauthorized | total control over both the type of |
| | usage of their | information they want to share and |
| | information. | whom they share it with. |

The properties of assets may be defined as follows:

Privacy: the right to prevent unwelcome and unauthorized intrusions

Secrecy: the right to prevent disclosure of information

Confidentiality: the right to release information with restrictions to a entity of choice

Commerciality: the right to sell information at a fair market price

Reciprocity: the right to receive value for the information provided

Interoperability: the right to transparency in the manner in which information is shared

Control: the right to choose who gets access to information and what it is used for

### CUSTOMER INFORMATION TRADING EXCHANGE

Business Description

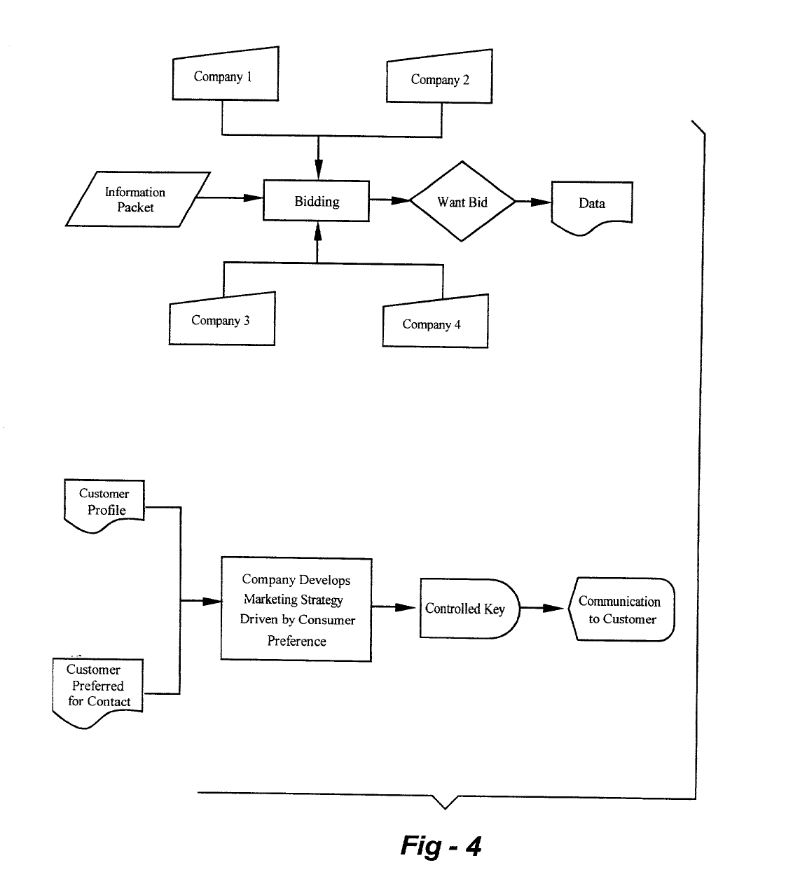

In accordance with the invention, an information exchange will be established enabling customer information to be traded (see FIG. 3). This will be carried out through a secure, encryption driven platform where customers will willingly share their information. Using an inventive pricing algorithm, an “infomediary” (a term coined by John Hagel, Partner at McKinsey) between the customer and companies will be used to service purchase intent. This will be mediated through a bidding process so as to realize maximum possible price for the information on behalf of the customer. The company that wins the bid for the information will get the right to use the information and directly market to the customer (see FIG. 4).

An encryption driven communication platform or “circle of influence” will be created allowing customer to invite companies to communicate with customers in a regulated manner when they are “purchase ready.” This will create a paradigm shift in managing customer demand and influencing customer decisions. When implemented, this will result in reduced marketing costs through higher conversion rates and improved customer satisfaction. As a byproduct, the data collected from customers will be used to create customized aggregate level market research reports that give companies a deeper understanding of their customers. It will also use the data to create quarterly indices that reflect customer sentiment.

It is an object of the business model underlying this invention to facilitate the transfer of information in a regulated manner from the customer to the client (i.e., durable and lifestyle goods manufacturers in the U.S.) in exchange for the value of this information. An intermediary (the “infomediary”) in the process will facilitate the information being captured and used in a controlled manner. This will create an environment of trust, wherein the customers will willingly share information about purchase intent, in exchange for an incentive package that compensates them for the value of their information. Measures will further be taken to ensure that the information is used in a manner dictated by the customer.

In order to facilitate the exchange of information for value, the information exchange will facilitate the buying and selling of information packets. These data packet will be ascribed a defined value and floated on the exchange to start the bidding process. A successful bid will give the vendor the right to access this information and use it to market to the customer based on pre-set conditions.

Direct marketing will mediated through the circle of influence. This will be a mechanism for clients to directly market to customers upon receiving an invitation to do so. Customers will be given total control over who has access to their information and what they do with it. This direct marketing effort will use several channels such as email and personalized websites to reach the customer. Cryptology will preferably be used to regulate the flow of information between its clients and its customers.

### Registration Process

If a customer is a first time user, and/or interested in joining the community, he/she will be required to register with the system. Upon verification of password and email information, the customer will gain access to their “personal space”, from which they can access the site map to navigate to areas such as personal profile, express interest/request information, on-line community, communications center, personal information bank, circle of influence, and information exchange.

The customer will be required to provide a username (which will preferably be used to create an email address), password and an existing email address. The customer will also be required to select a “pin” which will be used to verify identify in the event direct communication or authorization of some action taken by the customer will be required. A notification of “pin selection” will be sent to the customer's new email address and all future communications may be managed through an integrated mail system located within the customer's personal space. The customer will also be given a tag which will serve as identification for the customer on information packets, while the customer is browsing or shopping on the Internet. Eventually this tag will be used even offline as the customer shops in retails stores.

Creating/Editing Personal Profile

A new registrant will first be asked to create a personal profile. To do so, they can enter the “circle of trust” area and will be asked to participate in a baseline questionnaire, which will include questions relating to both demographics and psychographics. This list was compiled, and will be updated in accordance with the benchmarking of current best practices for information collected for the purpose of developing accurate and beneficial consumer profiles.

The customer will be given the option to continuously edit or update their profile so that it reflects the most accurate representation of his current status. For example, if an existing customer relocates or receives a substantial income raise these changes may impact the value of their information package and impact serviceability.

Request for Information/Express Interest

Once the customer is registered with the system they can use the site to research any one of the products (including durable products) for which they are interested in purchasing at some time in the near future. The customer can request detailed information pertaining to product specifications, pricing, availability etc. by completing a brief questionnaire. A typical product specific questionnaire would contain data such as model type, color preferences, payment preference, etc.

In addition, the customer would be capable of selecting manufacture(s) they want to solicit information from (using a pull down menu), specify the required turn around time for requested information, and also specify the channel through which they want to be contacted in the future. A list of available options by which a customer may receive requested information includes, a) side-by-side comparison of options and pricing in the circle of influence area, b) contact by manufacturer's representative via phone and/or fax, and contact via the intermediary email network. If only one manufacturer is selected a “request package” will preferably be forwarded to a competitor so as to solicit a mystery bid. The customer always has the choice on whether to enter the mystery box or not to enter.

On-Line Community

A customer can enter the on-line community, which will be a forum through which existing customers may share their experiences with the system. A message board will give each user the ability to read comments by others and/or give access to start a new topic of conversation.

Communications Center

Each customer will also have access to a communications center from which they may manage their e-mail. This email system will be built on encryption technology, enabling the intermediary to regulate the exchange of information between clients and customers. The intermediary will ensure that the customers have total control over what their information is used for and that clients contact customers only in the manner specified. This service will be similar to that which is offered by Yahoo, Hotmail and others. If a consumer requests to be contacted by a corporation via email, then the customer may enter the communication center and see if they have received any information regarding a match of interests between the corporation and themselves. The email system will provide secure transmission of data and we believe would thus provide customers with an incentive to use it for added privacy.

Personal Information Savings Account (PISA)

Each customer will preferably be given a Personal Information Savings Account, or PISA. Upon registration into the system, and completion of the personal profile, the customer's PISA will be credited an amount representing the base value of the personal information. The account will also contain a list of purchases made through the system along with the amount of discount received from the manufacturer and payment received for sharing information on the network. The balance will be represented on the desktop page with recent activity, growth in value, also reported on the desktop page.

Information Exchange

An Information Exchange in form of a secure network site will be established to ensure that companies have the option to register their brand or company an industry code and a contact email address on the site for a monthly fee. In return, the company would be contacted when a customer information packet is generated that meets their needs. The market price will reflect the value of the right to market to the customer, given the time frame, analysis of internal operational efficiencies, and the number of competitors in the running.

A valuation model according to the invention will present an intrinsic value of this information based on several key parameters such as time to purchase, probability of purchase, and current cost of acquisition for the product industry. The market price must meet the minimum valuation price. The number of companies allowed to market to the customer will be limited to three unless expressly specified by the customer.

Valuation of Information

This invention is built around the fact that relevant and timely information about the right customer, made available to the right vendor, has tremendous value. This value will be a function of the time to purchase (T), the probability of purchase (Y) and the propensity to switch (P) or variety seeking. The algorithm permits an estimate of the probability of purchase for a specific product category given a specific demographic type. This allows a vendor to pay for information based on the likelihood that the customer will buy.

A pricing model is used to estimate the value of information made available at a given point in time, as follows:

Value=f(Nₙ¹·Pₙ¹·Vₙ¹)Nₓ¹Nₓ¹

The value of the customer's information is a function of N (needs), P (products that can satisfy each need) and V (number of vendors that can satisfy each need). Each of these ranges from 1 to N, depending on the number of needs, products and vendors. Every customer has, over a relevant time period, multiple needs, each need, which can often be satisfied by multiple products and multiple vendors. Since each vendor would like the opportunity to reach as many potential customers as possible, they spend resources attempting to get to know the customer. This money can now be directly channeled to the customer, therefore making the potential lifetime value of information substantial.

The customer information packets will be coded by customer tag, industry, product category, and indicated time to purchase. For example, a customer requesting information on a BMW luxury sports sedan for purchase within the next 3 months may be assigned the code→AFLS3 (for Automobile Foreign Luxury Sports 3). In addition, the companies will be able to search and sort customer information packets based on these criteria. Companies can then enter the exchange and bid for customer information packets that they have already queried. A successful bid will give them access to the circle of influence, allowing them to market to these customers.

Mystery Box

The “Mystery Box” is a page that will contain information about an unsolicited bid or offer for a comparable product offering by a competing company for a situation in which the customer is a dedicated customer to company x and has expressed interest in only that company. The Mystery Box would be located on the home page and will change color (or some other visual cue) to signify the presence of an unsolicited offer) when a bid exists. The customer has the flexibility to enter this page depending on their time availability etc. and would benefit by getting data on a product they may have not known about before and at an even better price.

Circle of Influence™ (COI)

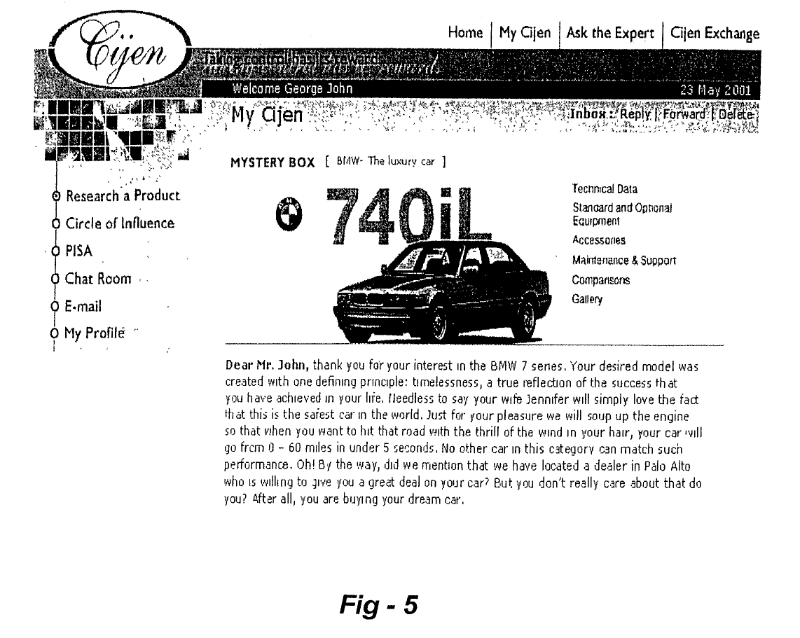

The customer may enter the circle of influence area to gain access to requested information on available products/durable goods such as detailed specifications, pictures, contact information, and pricing (see FIG. 5). The site will consist of several pop-up windows that contain an area to store product images, a text window to highlight product specifications, and/or contain video/audio files about the product. The customer will have the ability to directly contact any or all of the companies shown via the communications center. The clients will use this circle of influence space to attempt to highlight the benefits of their products in direct response to the specific attributes specified by the customer.

Privacy Tools

Security during the process of sharing, storing and retrieving data is critical. Customers will be offered software allowing them to make purchases on-line anonymous or software that may be integrated into a browser and masking a user's movements as they surf the Internet. A 128-bit encryption key created by RSA (Rivest-Shamir-Adleman) Technologies will preferably be used to encrypt the information. This will prevent dissemination of information both during capture and transfer. The information captured will be shipped to an information warehouse in encrypted form, from where it will be segregated from data storage into a data warehouse and a data mart. This will facilitate the creation of a Demilitarized Zone (DMZ) between the two storage units as well as between the website and the datamart. This DMZ, a firewall between the interface (website) and the datamart, and the datamart and the warehouse, will ensure that access to this information is secure and authenticated. This will protect the integrity of the information.

As shown in FIG. 6, an asymmetric encryption will be used to ensure that the intermediary retains control over the process of transferring information from customers to clients. An asymmetric encryption uses both public and private encryption keys to encode and decode information. Current encryption processes allow two entities to use a public encryption key to encode data and a private encryption key to decode data. This makes the transfer of information secure. However, in the event that the two entities are unknown to each other (e.g. a customer and a company) they require the presence of a third party or authenticator, that will regulate the flow of information. This authenticator then turns a third encryption key, which allows the flow of information to take place in a pre-set and controllable fashion. The intermediary will therefore play the role of this authenticator, ensuring that the customer is contacted according to the protocols that they have set. This will ensure total control over the process to ensure that customers maintain their privacy.

Customers will also be able to “front load” most of their information sharing. This will reduce the need to share general preference details frequently. A one-click transfer of such information will preferably be implemented by creating three separate profiles of the customer depending on the level of information that the customer wants to share. Customers will also be allowed to synchronize information between different devices such as PDAs, computers, and wireless phones.

The client side will feature an automated response system based on pre-defined parameters allowing them to bid on the customers business. The clients will set a range of offers based on the customer's demographics and psychographics. Clients will be given access to the profile of the customer. They will be allowed to query the database upon winning the bid.

### EXAMPLE

Robert recently received an increase se in salary. He wants to buy a new car and can afford to spend approximately $500 per month. This allows him to purchase a $40,000.00 car if he leases the car. Robert, being a member of the Information Exchange according to this invention, will share this information about his desire to purchase an automobile. The information will contain information about his purchase intent (desire to buy the product), his preferences regarding the product (leather seats, horsepower, safety etc.) and his psychographic details (what pleases him, what motivates him, etc.).

Robert's information packets shall be coded by customer tag, industry, product category, and indicated time to purchase. For example, a customer requesting information on a BMW luxury sports sedan for purchase within the next 2 weeks may be assigned the code→RAFLS2W (for Robert Automobile Foreign Luxury Sports 2 weeks). This information will be validated by checking Robert's past purchase history, if any, with the system, as well as overlay a consumer psychologist's evaluation of the demographic type within which Robert falls. This will verify whether a person in his demographic type that Robert falls under would be likely to buy such a product.

Upon verification, collaborative filtering techniques will be applied to find products that match Robert's needs. This process is used to match a customer's preferences with product attributes. Assume that Automobile Company XYZ, Inc, All America Inc., and Automobile Company ABC, Inc. are selected in accordance with the invention as being able to offer products that meet Robert's needs. The pricing algorithm implemented by the invention will be used to measure the value of Robert's information being made available to these three companies immediately. Using the algorithm, the price of Robert's information will reflect the value of the right to market to the customer, given the time-frame, analysis of internal operational efficiencies, and the number of competitors in the running. The ultimate price will reflect the value of this information based on several key parameters such as time to purchase, probability of purchase, and current cost of acquisition for the product industry.

The three selected companies will be notified, via email or other communication means, that Robert is in the market to buy an automobile and that based on collaborative filtering, these companies can fulfill his needs. The three automobile companies will then be allowed to query the data using a code provided to them that will allow them to access the database containing Robert's information. However, the companies will not be given access to the identity of Robert or any means to directly communicate with him.

If the companies feel that based on his expressed preferences, indeed, they can meet his needs, they will make an offer for the right to buy the information and the right to market directly to Robert. Using the preferences set by Robert, which might be to allow all three companies to market to him or just the highest bidder for the information or a mix of this, the right to the information will be awarded to the companies as appropriate.

The automobile companies will then be able to communicate directly with Robert via secure, encrypted links. This communication can be a mixture of one or many communication channels like email, telephone call, brochure etc. In this communication they will be free to highlight any or all parts of their product that they feel meet the requirements of Robert or is able to entice him to buy their product.

Based on this marketing effort, Robert will make up his mind and presumably purchase one of the products offered. Both Robert and the selected automobile company will inform the intermediary of the purchase and the information regarding Robert will be updated. In addition, Robert's Personal Information Savings account (PISA) will also be credited with the appropriate value that his information has accessed after deducting a commission for selling the information on behalf of Robert.

We claim:

1. A method of evaluating and trading purchaser information, comprising the steps of:
capturing purchasing information from a buyer during the purchase cycle converting the information into an asset that the buyer can own
identifying potential sellers based upon the purchasing information;
conducting an auction whereby the potential sellers or merchants bid on the information without knowing the details thereof; and
selling the information to the highest bidder, enabling that seller or sellers to market directly to the buyer.

2. The method of claim 1, wherein the buyer is interested in buying durable goods.

3. The method of claim 1, wherein the durable goods includes a motor vehicle.

4. The method of claim 1, including the step of applying a formula to the information to arrive at a valuation therefore.

5. The method of claim 4, wherein the buyer is compensated as a function of the valuation.

6. The method of claim 1, wherein the communications between the buyer and seller are encrypted.

7. The method of claim 1, including the step of compiling the information from a plurality of customers to generate market research reports.

8. The method of claim 1, wherein the information includes demographics and psychographics.

9. The method of claim 8, wherein at some of the information is gathered through a questionnaire completed by the buyer during the registration thereof.

10. The method of claim 1, wherein the buyer is permitted to update the information if their purchasing ability or intent changes.

11. The method of claim 1, wherein, if only one seller is selected, one or more competitors are solicit to submit additional bids unknown to the buyer.

12. The method of claim 1, further including the step of setting up a personal information savings account for the seller containing one or more of the following:
a) a history of purchases made by the buyer through the system,
b) the amount of discount(s) received from sellers, and
c) compensation received for sharing the purchasing information.

13. A method of evaluating and trading purchaser information, comprising the steps of:
creating an information exchange in the form of a secure network site enabling potential sellers of goods or services to register their company and offerings;
registering potential buyers by gathering demographic and psychographic information regarding an imminent purchase of the goods or services;
applying a formula to the information to arrive at a valuation therefore.
conducting an auction whereby the potential sellers bid on the information without knowing certain details about the buyers; and
selling the information to the highest bidder, enabling that seller or sellers to market directly to the buyer; and
compensating the buyer as a function of the valuation if the buyer purchases the goods or services.

14. The method of claim 13, wherein the buyer is interested in buying durable goods.

15. The method of claim 14, wherein the durable goods includes a motor vehicle.

16. The method of claim 13, wherein valuation of the information is based upon a market price derived from one or more of the following:
a) the right to market to the buyer,
b) the time frame of the buyer's purchasing decision,
c) the seller's internal operational efficiency, and
d) the number of competing sellers in running.

17. The method of claim 13, wherein the communications between the buyer and seller are encrypted.

18. The method of claim 13, including the step of compiling the information from a plurality of customers to generate market research reports.

19. The method of claim 13, wherein the buyer is permitted to update the information if their purchasing ability or intent changes.

20. The method of claim 13, wherein, if only one seller is selected, one or more competitors are solicit to submit additional bids unknown to the buyer.

21. The method in claim 1 in which the vendor (our client) markets in a personalized and individualized manner to the customer based on the specific attributes expressed by the customer during the purchase cycle.
